(19) United States
(12) Patent Application Publication
(10) Pub. No.: US 2026/0196583 A1
(43) Pub. Date: Jul. 9, 2026

(54) BATTERIES AND BATTERY SENSORS

(71) Applicant: FORD GLOBAL TECHNOLOGIES, LLC, Dearborn, MI (US)

(72) Inventors: Justin PUREWAL, Ann Arbor, MI (US); Chansun PARK, Southfield, MI (US)

(21) Appl. No.: 19/012,129

(22) Filed: Jan. 7, 2025

(51) Int. Cl. H01M 10/48; G01N 27/12; H01M 10/0525; H01M 10/42; H01M 50/105; H01M 50/121; H01M 50/131; H01M 50/211

(52) U.S. Cl. CPC H01M 10/48; G01N 27/125; H01M 10/0525; H01M 10/425; H01M 50/105; H01M 50/121; H01M 50/131; H01M 50/211; H01M 2010/4271; H01M 2010/4278

(57) ABSTRACT

A lithium-ion cell includes a polymer film enclosing an electrode stack and a metal hydride-based sensor, which is laminated on the polymer film. The sensor's electrical resistance increases in response to hydrogen gas exposure, a byproduct of lithium plating. An inductive system with a primary coil positioned outside the polymer film and a secondary coil integrated with the sensor enables wireless signal transmission. When the sensor detects hydrogen, the secondary coil transmits a signal to the primary coil, which may be used to inform a battery management system, allowing for real-time monitoring.

### TECHNICAL FIELD

This disclosure relates to battery technology.

### BACKGROUND

Traditional electrochemical signals (e.g., coulombic efficiency, dV/dt) are sometimes used as indicators of lithium plating under standard conditions.

### SUMMARY

A lithium-ion cell includes a polymer film enclosing an electrode stack, a metal hydride-based sensor laminated on the polymer film and configured to increase electrical resistance in response to hydrogen gas exposure, and an inductive system with a primary coil outside the polymer film and a secondary coil integrated with the metal hydride-based sensor. The secondary coil is configured to transmit a signal to the primary coil responsive to the increase. The metal hydride-based sensor may be configured to detect a hydrogen gas presence threshold of 1 part-per-million. The polymer film may be a gas-permeable plastic. The metal hydride-based sensor may be palladium-based. The metal hydride-based sensor may be palladium-nickel or palladium-silver alloy. The secondary coil may be encapsulated in a thermally insulating material. The primary coil and secondary coil may operate below 500 kHz. The metal hydride-based sensor may include a temperature sensor. The metal hydride-based sensor may be configured to revert to a baseline resistance level upon dissipation of hydrogen gas. The secondary coil may be configured to communicate with a battery management system that adjusts charging parameters based on hydrogen detection.

A lithium-ion battery pack includes a plurality of lithium-ion cells, each encased in a permeable membrane with a metal hydride wire positioned inside the permeable membrane, a primary inductive coil embedded within a foam layer positioned between adjacent lithium-ion cells of the plurality to power the metal hydride wire, and a secondary inductive coil integrated with each metal hydride wire, configured to transmit a signal to the primary coil indicating an increase in resistance of the metal hydride wire caused by exposure to hydrogen gas. The lithium-ion cells may include cathode active materials such as nickel cobalt aluminum oxide, lithium nickel manganese cobalt oxide, lithium iron phosphate, lithium titanate oxide, lithium manganese oxide, lithium cobalt oxide, or lithium-rich nickel manganese cobalt battery chemistries, and anode materials such as graphite, silicon, or lithium metal. The primary inductive coil may be made from a copper, aluminum, or a litz wire material. The secondary inductive coil may be embedded in a core material which may be ferrite, iron powder, or nickel-zinc ferrite. The metal hydride wire may be composed of palladium, palladium-silver alloy, nickel-palladium alloy, or a palladium-copper alloy material. The metal hydride wire may be coated with a layer of aluminum oxide, silicon dioxide, or titanium dioxide. The permeable membrane surrounding each lithium-ion cell may be made of polyimide, polytetrafluoroethylene, polyethylene terephthalate, silicone-coated polymer, or fluorinated ethylene propylene.

A method for detecting lithium plating in a lithium-ion cell includes detecting hydrogen gas produced by lithium plating via an increase in resistance of a metal hydride-based sensor within a polymer film enclosing a lithium-ion cell, and transmitting a signal corresponding to the increased resistance of the metal hydride-based sensor using a secondary inductive coil integrated with the metal hydride-based sensor to a primary inductive coil positioned outside the polymer film. The method may also integrate the signal from the primary inductive coil into a battery management system to adjust charging parameters based on detected hydrogen levels. The method may also trigger an alert within the battery management system if hydrogen detection exceeds a predefined threshold indicative of lithium plating.

### BRIEF DESCRIPTION OF THE DRAWINGS

FIGS. 1-4 are schematic diagrams of a hydrogen gas detection sensor within a lithium-ion battery cell; and

FIG. 5 is a flowchart of a hydrogen gas detection system utilizing a hydrogen gas detection sensor within a lithium-ion battery cell.

### DETAILED DESCRIPTION

In accordance with this disclosure, detailed embodiments of a hydrogen detection system, inductive transmission methods, and related lithium-ion battery safety mechanisms are provided. These embodiments represent an approach to early detection of lithium plating by monitoring hydrogen gas levels within lithium-ion cells. The figures and descriptions included are illustrative and may not depict every possible variation or configuration of the system. Certain features may be emphasized or simplified to highlight key aspects of the hydrogen detection process and its mechanical and electronic components. Therefore, the specific structural and operational details described are not intended to limit the scope of the invention but to serve as a guide for those skilled in the art to implement various embodiments of the claimed invention.

The present disclosure relates to a real-time lithium plating detection system for lithium-ion (Li-ion) batteries, configured to sense deposition on the anode during rapid charging. Traditional methods for detecting lithium plating rely on electrochemical indicators, including coulombic efficiency, dV/dt, and end-of-cycle voltage shifts, but these indicators may be unreliable in typical drive-cycle conditions. This disclosure proposes H₂ as a chemical marker for lithium plating. H₂ gas is generated through a reaction between metallic lithium and polyvinylidene fluoride, a commonly used polymer binder in Li-ion electrodes. Unlike electrochemical signals, H₂ release provides a direct indication of lithium deposition, as it is released earlier than other gases, such as carbon monoxide, carbon dioxide, and hydrogen chloride, during lithium plating events.

The H₂ detection component may be a metal hydride-based sensor, which is highly sensitive and can detect H₂ at a presence threshold in the parts-per-million (PPM) level with response times on the order of seconds. Metal hydrides, which absorb hydrogen gas to form metal-hydrogen compounds, undergo changes in electrical resistivity when exposed to H₂, creating a clear and measurable signal. Suitable metal hydrides for this sensor include palladium-based hydrides, nickel-based hydrides, and palladium alloy hydrides all of which are highly sensitive and responsive to H₂. The sensor is incorporated as a thin film that may be embedded within the Li-ion cell without disrupting the cell's mechanical structure. To ensure the sensor's longevity and selectivity, it may be encapsulated in a gas-permeable plastic film that permits H₂ molecules to reach the sensor while blocking solvents and electrolytes that could degrade the device. An additional temperature sensor may be included to distinguish between resistivity changes caused by temperature fluctuations and those resulting from H₂ presence, thereby increasing the accuracy of the detection signal.

This detection system may be compatible with various Li-ion battery chemistries where lithium plating is a concern, particularly in those using graphite-based anodes. Lithium plating degrades the anode material regardless of the cathode type, so early detection is valuable across multiple chemistries, including lithium nickel cobalt aluminum oxide batteries, which are commonly used in electric vehicles, lithium nickel manganese cobalt oxide batteries, which offer a balance of energy density and longevity, lithium iron phosphate batteries, which, though less susceptible to lithium plating, still benefit from early detection in rapid charging applications, and lithium titanate oxide batteries, which generally resist lithium plating unless graphite is included as part of the electrode composition.

To enable wireless detection, the disclosure utilizes inductive coupling between a primary coil located outside the Li-ion cell and a secondary coil within the cell, which is connected to the metal hydride sensor. This wireless communication system eliminates the need for wiring, reducing chance of dissociation of physical connections. Inductive coupling operates on the principle of electromagnetic induction, which is an alternating current in the primary coil generating an oscillating magnetic field that induces a current in the secondary coil. The primary coil is situated within a foam compression pad between Li-ion cells in a battery array. This placement not only provides structural support and thermal insulation but also facilitates easy integration of the wireless reader module. When H₂ gas is detected, the metal hydride sensor changes its resistivity, generating a simple electrical signal that is transmitted from the secondary coil to the primary coil.

Data transmission through the battery pouch's non-ferrous layers, such as aluminum, is feasible due to the low-frequency signal generated by the H₂ detection event, which bypasses shielding effects to some degree. The received signal may then be relayed to the battery management system (BMS), which interprets the data as a measure of H₂ presence. Upon detecting elevated H2 levels, the BMS can dynamically adjust charging protocols, potentially reducing the charging rate or temporarily halting charging to prevent further lithium deposition.

This system's wireless, in-situ detection approach offers significant benefits, providing a highly selective, real-time detection method for lithium plating without requiring additional wired connections. The thin-film nature of the metal hydride sensor allows it to operate within the Li-ion cell without affecting the electrode structure. By protecting the sensor with a gas-permeable plastic film, the invention ensures resilience against the Li-ion electrolyte, making it suitable for use within the cell itself. Integrating the primary coil within the foam pad increases the reliability of data transmission, as the close proximity between the primary and secondary coils reduces signal interference.

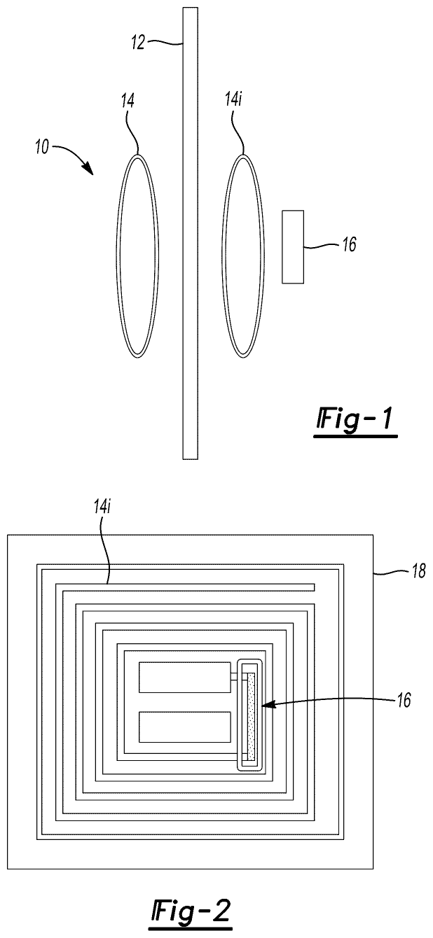

FIG. 1 shows a hydrogen sensor system within a battery cell 10. A pouch 12 separates a primary coil 14 positioned outside the pouch 12, while a secondary coil 14i is integrated with a metal hydride-based sensor 16 and located inside the pouch 12. The secondary coil 14i is configured to wirelessly transmit a signal indicating the increase in resistance to the primary coil 14, which allows for real-time hydrogen detection without needing a physical connection through the pouch 12. The primary and secondary coils 14, 14i, which are both inductive, may operate at a frequency below 500 kHz to maintain efficient inductive coupling through the polymer barrier, even with shielding effects from aluminum or other non-ferrous materials in the pouch 12. In FIG. 2 the secondary coil 14i is shown encapsulated in a semi-permeable plastic film 18, which may shield it from temperature fluctuations that might otherwise interfere with signal accuracy. Additionally, the metal hydride-based sensor 16 may be configured to revert to its baseline resistance level when hydrogen gas dissipates, enabling the metal hydride-based sensor 16 to reset and detect subsequent lithium plating events as they occur. This configuration supports a continuous monitoring cycle, with the secondary coil 14i capable of communicating with an external battery management system that may adjust charging parameters based on hydrogen detection.

The secondary coil 14i is structured in a spiral pattern to maximize inductive coupling efficiency with the primary coil 14 located outside the pouch 12. The metal hydride-based sensor 16, integrated within the secondary coil 14i, responds to hydrogen gas presence by increasing the electrical resistance of the metal hydride material in the metal hydride-based sensor 16. The metal hydride-based sensor 16 may be capable of detecting hydrogen gas at a presence threshold as low as 1 PPM.

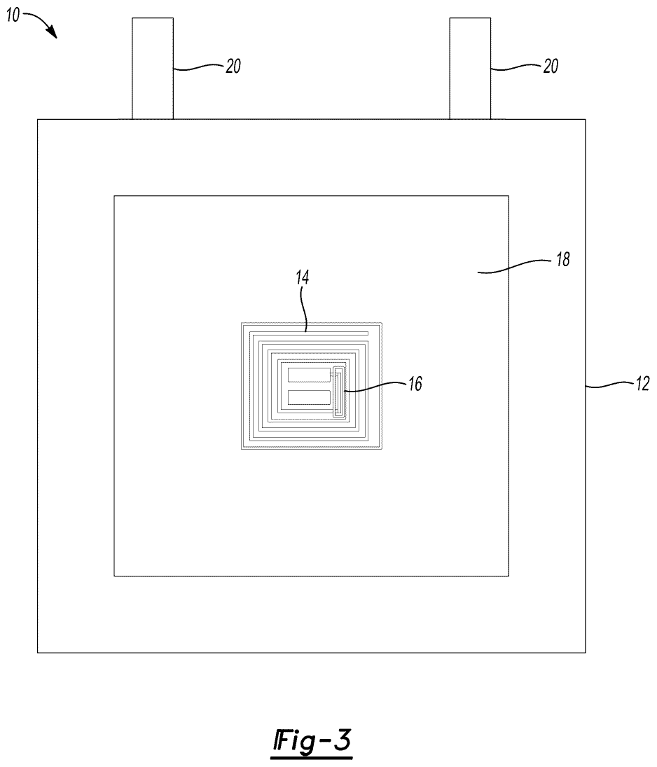

FIG. 3 shows the semi-permeable plastic film 18 encasing the metal hydride-based sensor 16, allowing selective permeability to hydrogen gas while blocking solvents and electrolytes that could degrade the sensor. The semi-permeable plastic film 18 may be made of polyimide, polytetrafluoroethylene, polyethylene terephthalate, silicone-coated polymer, or fluorinated ethylene propylene, each of these materials may be chosen for specific properties of gas permeability and chemical resistance. Battery tabs 20 extend from the semi-permeable plastic film 18, providing electrical connections for the battery cell 10. The metal hydride-based sensor 16 inside the pouch 12 may be palladium-based, such as in the form of palladium-nickel or palladium-silver alloys.

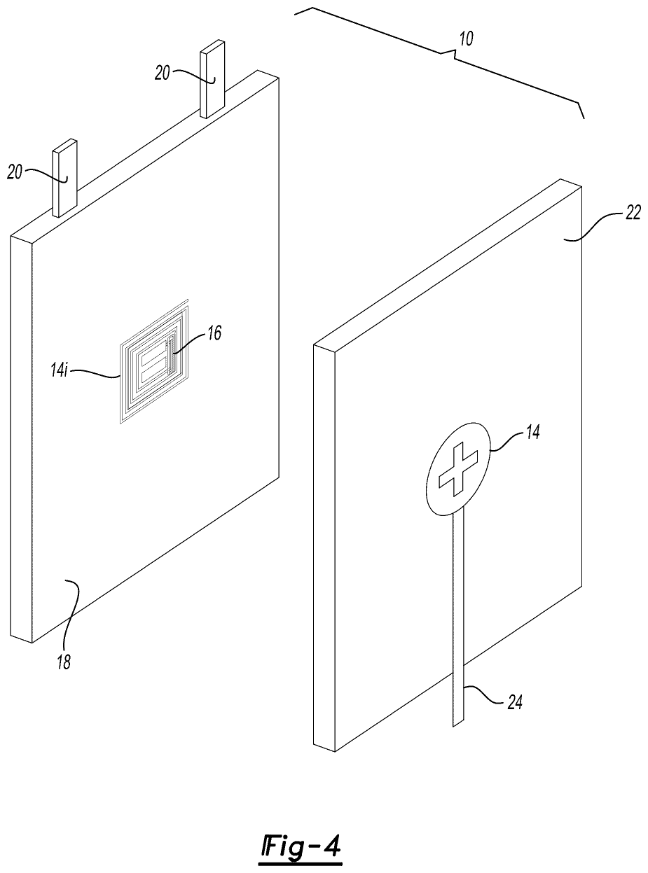

FIG. 4 shows the integration of the metal hydride-based sensor 16 within a stacked configuration such as in a battery pack, where insulating foam 22 is positioned between adjacent lithium-ion cells for thermal insulation and structural support. The primary coil 14 is embedded within the insulating foam 22, enabling it to wirelessly interact with the secondary coil 14i within each battery cell 10. The insulating foam 22 may act as a housing for the primary coil 14, while also protecting adjacent battery cells from physical or thermal interference. A supply wire 24 is connected to the primary coil 14, providing power for inductive coupling and acting as a data conduit to transmit information about hydrogen detection to a battery management system. The metal hydride-based sensor 16 within each cell may be composed of materials such as palladium, palladium-silver alloy, nickel-palladium alloy, or palladium-copper alloy, or other suitable hydrogen gas sensitive material.

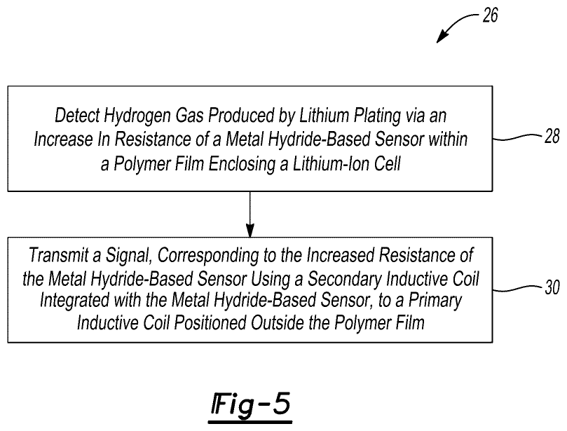

FIG. 5 is a flowchart 26 that outlines the operational method of the hydrogen gas detection system. In step 28 hydrogen gas produced by lithium plating is detected through an increase in the electrical resistance of the metal hydride-based sensor within a polymer film enclosing the lithium-ion cell. In step 30 a signal corresponding to this increased resistance is transmitted. This may be accomplished through the secondary inductive coil integrated with the metal hydride-based sensor, which communicates wirelessly to a primary inductive coil positioned outside the polymer film. This signal may then be processed by an external battery management system, which may adjust charging parameters to mitigate further lithium deposition and potential cell degradation. If the hydrogen detection exceeds a predefined threshold, the system may trigger an alert within the battery management system, prompting corrective action to protect the lithium-ion cell.

Unless explicitly specified otherwise, all numerical values and ranges relating to quantities, measurements, percentages, weights, and similar numerical references within this document should be understood as being preceded by the term “about,” even if “about” is not explicitly stated. This applies to values and ranges affected by standard measurement tolerances, manufacturing processes, material properties, and the intended functionality of the disclosed embodiments. For example, a threshold concentration specified as “1 part-per-million” should be interpreted as “about 1 part-per-million,” a frequency specified as “below 500 kHz” should be understood as “about below 500 kHz,” and a composition specified as “5 wt. % of a component” should be interpreted as “about 5 wt. % of a component.” Similarly, when ranges are provided, such as “100 to 200 units,” they should be interpreted as “about 100 to about 200 units.” Such variations are implicitly included within the scope of this disclosure.

Although specific embodiments of hydrogen detection systems, inductive transmission methods, and related lithium-ion battery mechanisms have been described in detail, these embodiments do not encompass all possible configurations. The language used in this specification is intended for illustrative purposes and should not be construed as limiting the scope of the invention. Variations and modifications may be made without departing from the fundamental principles of the invention. Furthermore, the features and elements of the disclosed embodiments may be combined in various ways to create additional embodiments that fall within the scope of the claimed invention, even if such combinations are not explicitly described in this specification.

What is claimed is:

1. A lithium-ion cell comprising:
a polymer film enclosing an electrode stack;
a metal hydride-based sensor laminated on the polymer film and configured to increase electrical resistance in response to hydrogen gas exposure; and
an inductive system with a primary coil outside the polymer film and a secondary coil integrated with the metal hydride-based sensor, wherein the secondary coil is configured to transmit a signal to the primary coil responsive to the increase.

2. The lithium-ion cell of claim 1, wherein the metal hydride-based sensor is configured to detect a hydrogen gas presence threshold of 1 part-per-million.

3. The lithium-ion cell of claim 1 wherein the polymer film is made of a gas-permeable plastic.

4. The lithium-ion cell of claim 1 wherein the metal hydride-based sensor is palladium-based.

5. The lithium-ion cell of claim 4 wherein the metal hydride-based sensor is selected from a group comprising palladium-nickel and palladium-silver alloys.

6. The lithium-ion cell of claim 1, wherein the secondary coil is encapsulated in a thermally insulating material.

7. The lithium-ion cell of claim 1 wherein the primary coil and secondary coil operate at a frequency below 500 kHz.

8. The lithium-ion cell of claim 1 wherein the metal hydride-based sensor also includes a temperature sensor.

9. The lithium-ion cell of claim 1 wherein the metal hydride-based sensor is configured to revert to a baseline resistance level upon dissipation of hydrogen gas.

10. The lithium-ion cell of claim 1 wherein the secondary coil is configured to communicate with a battery management system that adjusts charging parameters based on hydrogen detection.

11. A lithium-ion battery pack comprising:
a plurality of lithium-ion cells, each encased in a permeable membrane with a metal hydride wire positioned inside the permeable membrane;
a primary inductive coil embedded within a foam layer positioned between adjacent lithium-ion cells of the plurality to power the metal hydride wire; and
a secondary inductive coil integrated with each metal hydride wire, configured to transmit a signal to the primary inductive coil indicating an increase in resistance of the metal hydride wire caused by exposure to hydrogen gas.

12. The lithium-ion battery pack of claim 11 wherein the lithium-ion cells have battery chemistries selected from the group consisting of lithium nickel cobalt aluminum oxide, lithium nickel manganese cobalt oxide, lithium iron phosphate, lithium titanate oxide, lithium manganese oxide, lithium cobalt oxide, and lithium-rich nickel manganese cobalt.

13. The lithium-ion battery pack of claim 11 wherein the primary inductive coil is made from a material selected from the group consisting of copper and aluminum.

14. The lithium-ion battery pack of claim 11 wherein the secondary inductive coil is embedded in a core material selected from a group consisting of ferrite, iron powder, and nickel-zinc ferrite.

15. The lithium-ion battery pack of claim 11 wherein the metal hydride wire is composed of a material selected from a group consisting of palladium, palladium-silver alloy, nickel-palladium alloy, and palladium-copper alloy.

16. The lithium-ion battery pack of claim 11 wherein the metal hydride wire is coated with a material selected from a group consisting of aluminum oxide, silicon dioxide, and titanium dioxide.

17. The lithium-ion battery pack of claim 11 wherein the permeable membrane surrounding each lithium-ion cell is made from a material selected from a group consisting of polyimide, polytetrafluoroethylene, polyethylene terephthalate, silicone-coated polymer, and fluorinated ethylene propylene.

18. A method for detecting lithium plating in a lithium-ion cell comprising:
detecting hydrogen gas produced by lithium plating via an increase in resistance of a metal hydride-based sensor within a polymer film enclosing a lithium-ion cell; and
transmitting a signal, corresponding to the increased resistance of the metal hydride-based sensor using a secondary inductive coil integrated with the metal hydride-based sensor, to a primary inductive coil positioned outside the polymer film.

19. The method of claim 18, further comprising integrating the signal from the primary inductive coil into a battery management system to adjust charging parameters based on detected hydrogen levels.

20. The method of claim 19, further comprising triggering an alert within the battery management system responsive to hydrogen detection exceeding a predefined threshold indicative of lithium plating.
